(19) United States
(12) Patent Application Publication
(10) Pub. No.: US 2010/0140357 A1
(43) Pub. Date: Jun. 10, 2010

(54) Point-of-transaction checkout system

(76) Inventors: Thomas Roslak, Northport, NY (US); Shane MacGregor, Forest Hills, NY (US); Graham Marshall, Shoreham, NY (US)

Correspondence Address: MOTOROLA, INC., 1303 EAST ALGONQUIN ROAD, IL01/3RD, SCHAUMBURG, IL, 60196, US

(21) Appl. No.: 12/316,109

(22) Filed: Dec. 9, 2008

(51) Int. Cl. G06K 7/10

(52) U.S. Cl. 235/462.43

(57) ABSTRACT

A checkout system employs a bi-optical workstation having a first window located in a generally horizontal plane, and a second window located in a generally upright plane that intersects the generally horizontal plane. A data capture arrangement at the workstation captures through at least one of the windows data associated with products to be checked out by a customer. Both of the windows are positioned to face and be accessible to the customer, preferably by moving the workstation, for enabling the customer to interact with the workstation in a self-service mode of operation.

### BACKGROUND OF THE INVENTION

In the retail industry, flat bed laser readers, also known as horizontal slot scanners, have been used to electro-optically read one-dimensional bar code symbols, particularly of the Universal Product Code (UPC) type, at full-service, point-of-transaction checkout systems operated by checkout clerks in supermarkets, warehouse clubs, department stores, and other kinds of retailers for many years. As exemplified by U.S. Pat. No. 5,059,779; U.S. Pat. No. 5,124,539 and U.S. Pat. No. 5,200,599, a single, horizontal window is set flush with, and built into, a horizontal countertop of the system. Products to be purchased bear identifying symbols and are typically slid by the clerk across the horizontal window through which a multitude of scan lines is projected in a generally upwards direction. When at least one of the scan lines sweeps over a symbol associated with a product, the symbol is processed and read. The multitude of scan lines is typically generated by a scan pattern generator which includes a laser for emitting a laser beam at a mirrored component mounted on a shaft for rotation by a motor about an axis. A plurality of stationary mirrors is arranged about the axis. As the mirrored component turns, the laser beam is successively reflected onto the stationary mirrors for reflection therefrom through the horizontal window as a scan pattern of the scan lines.

It is also known to provide a checkout system not only with a generally horizontal window, but also with an upright or generally vertical window that faces the clerk at the system. The upright window is oriented generally perpendicularly to the horizontal window, or is slightly rearwardly or forwardly inclined. The laser scan pattern generator within this dual window or bi-optical terminal or workstation also projects the multitude of scan lines in a generally outward direction through the upright window toward the clerk. The generator for the upright window can be the same as or different from the generator for the horizontal window. The clerk slides the products past either window, e.g., from right to left, or from left to right, in a “swipe” mode. Alternatively, the clerk merely presents the symbol on the product to a central region of either window in a “presentation” mode. The choice depends on clerk preference or on the layout of the system.

Sometimes, the upright window is not built into the system as a permanent installation. Instead, a vertical slot scanner is configured as a portable reader that is placed on the countertop of an existing horizontal slot scanner in a hands-free mode of operation. In the frequent event that large, heavy, or bulky products, which cannot easily be brought to the reader, have symbols that are required to be read, then the clerk may also manually grasp the portable reader and lift it off, and remove it from, the countertop for reading the symbols in a handheld mode of operation.

As advantageous as these laser-based, point-of-transaction systems are in processing transactions involving products associated with one-dimensional symbols, each having a row of bars and spaces spaced apart along one direction, these systems cannot process stacked symbols, such as Code 49 that introduced the concept of vertically stacking a plurality of rows of bar and space patterns in a single symbol, as described in U.S. Pat. No. 4,794,239, or two-dimensional symbols, such as PDF417 that increased the amount of data that could be represented or stored on a given amount of surface area, as described in U.S. Pat. No. 5,304,786. Both one- and two-dimensional symbols, as well as stacked symbols, can be read by employing imaging readers each having a solid-state imager which has a one- or two-dimensional array of cells or photosensors that correspond to image elements or pixels in a field of view of the imager. Such an imager may include a one- or two-dimensional charge coupled device (CCD) or a complementary metal oxide semiconductor (CMOS) device, as well as associated circuits for producing electronic signals corresponding to the one- or two-dimensional array of pixel information over the field of view.

It is therefore known to use a solid-state imager for capturing a monochrome image of a symbol as, for example, disclosed in U.S. Pat. No. 5,703,349. It is also known to use a solid-state imager with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

It is also known to install the solid-state imager, analogous to that conventionally used in a consumer digital camera, in a bi-optical, point-of-transaction workstation, as disclosed in U.S. Pat. No. 7,191,947, in which the dual use of both the solid-state imager and the laser scan pattern generator in the same workstation is disclosed. It is possible to replace all of the laser scan pattern generators with solid-state imagers in order to improve reliability and to enable the reading of two-dimensional and stacked symbols, as well as other targets.

All of the above-described systems are typically operated by checkout clerks. In an effort to reduce, if not eliminate, the need for checkout clerks and their associated labor cost, and to improve the speed and efficiency of the checkout operation, a number of self-service, point-of-sale, checkout systems have been proposed. For example, see U.S. Pat. No. 6,354,496. A self-service checkout system is operated by the customer without the aid of the checkout clerk. During operation of the self-service checkout system, the customer retrieves the individual products for purchase from a shopping cart or basket and/or from an entrance conveyor belt at the countertop, and moves the retrieved individual products across, or presents the individual products to, a horizontal window of a horizontal slot scanner to read their respective symbols, and then places the read products onto an exit conveyor belt at the countertop for delivery to a bagging station, or directly into carry-out bags, if desired. The customer then pays for his or her purchases either at the self-service checkout system if so equipped with a credit/debit card reader, or at a central payment area that is staffed by a store employee. Thus, the self-service checkout system permits the customer to select, itemize, and, in some cases, pay for his or her purchases, without the assistance of the retailer's personnel.

However, self-service is not available if the aforementioned and increasingly popular, bi-optical workstation is installed at a checkout system. The upright window faces the clerk, not the customer. A rear wall of the bi-optical workstation rises from the countertop and faces the customer. As a result, the customer does not have ready access to either window of the bi-optical workstation and cannot assist in the checkout procedure, even if the customer wanted to, because the rear wall blocks such access. This lack of self-service potentially causes such bi-optical workstations to go unused or underutilized, and their expense to be economically unjustified. Bi-optical workstations occupy valuable real estate in a retailer's operation, which might otherwise be used for self-service systems. Bi-optical workstations are not readily convertible into self-service systems.

### SUMMARY OF THE INVENTION

One feature of this invention resides, briefly stated, in a checkout system and method in which a bi-optical workstation has a first window located in a generally horizontal plane, and a second window located in a generally upright plane that intersects the generally horizontal plane. Both of the windows are positioned to face and be accessible to a customer for enabling the customer to interact with the workstation in a self-service mode of operation. A data capture arrangement at the workstation is operative for capturing through at least one of the windows data associated with products to be checked out by the customer during the self-service mode.

In a preferred embodiment, the data are indicia, typically one- or two-dimensional bar code symbols, on the products, and the data capture arrangement includes an electro-optical reader for electro-optically reading the indicia. The reader is advantageously an imaging reader that operates by image capture, and includes a plurality of solid-state imagers for capturing light from the indicia through the windows along different fields of view. Each imager preferably comprises a two-dimensional, charge coupled device (CCD) array or a complementary metal oxide semiconductor (CMOS) array. Each imager includes an illuminator for illuminating the indicia with illumination light from one or more illumination light sources, e.g., one or more light emitting diodes (LEDs). A controller is operative for controlling each illuminator to illuminate the indicia, for controlling each imager to capture the illumination light returning from the indicia over an exposure time period to produce electrical signals indicative of the indicia being read, and for processing the electrical signals to read the indicia. Each illuminator is only operative during the exposure time period. Each imager is controlled to capture the light from the indicia during different exposure time periods to avoid mutual interference among the illuminators.

In a preferred embodiment, the workstation is supported by a support surface, such as a countertop of a checkout stand. Advantageously, an entrance conveyor belt is located at the support surface at one side of the workstation, for conveying the products placed on the entrance conveyor belt by the customer to the workstation. An exit conveyor belt is located at the support surface at the opposite side of the workstation, for conveying the products placed on the exit conveyor belt by the customer away from the workstation, preferably to a bagging area.

The workstation is relatively inexpensive to install, and can be positioned on the countertop so that its windows both face and are accessible to the customer, thereby maximizing its utilization. Preferably, the workstation is mounted on a movable support structure, such as a turntable, for rotation on the countertop, thereby enabling the windows to face and be accessible either to the clerk for tradtitional clerk service, or to the customer for either self-service or clerk-assisted service, simply by rotating the workstation. The checkout stand is thus easily converted from traditional clerk service to self-service or clerk-assisted service, without requiring structural modification to the existing checkout stand. The system reduces, if not eliminates, the need for checkout clerks and their associated labor cost, and improves the speed and efficiency of the checkout operation.

In accordance with another feature of this invention, the method is performed by configuring a bi-optical workstation with a first window located in a generally horizontal plane, and with a second window located in a generally upright plane that intersects the generally horizontal plane, by positioning both of the windows to face and be accessible to a customer for enabling the customer to interact with the workstation in a self-service mode of operation, and by capturing through at least one of the windows data associated with products to be checked out by the customer during the self-service mode.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a broken-away, perspective view of a checkout system employing a dual window, bi-optical, point-of-transaction workstation or self-service terminal operative for reading indicia on products in accordance with the present invention;

FIG. 2 is a part-sectional, part-diagrammatic, schematic view of the workstation of FIG. 1; and

FIG. 3 is a top plan view of the checkout system of FIG. 1 in accordance with this invention.

### DETAILED DESCRIPTION OF THE PREFERRED EMBODIMENTS

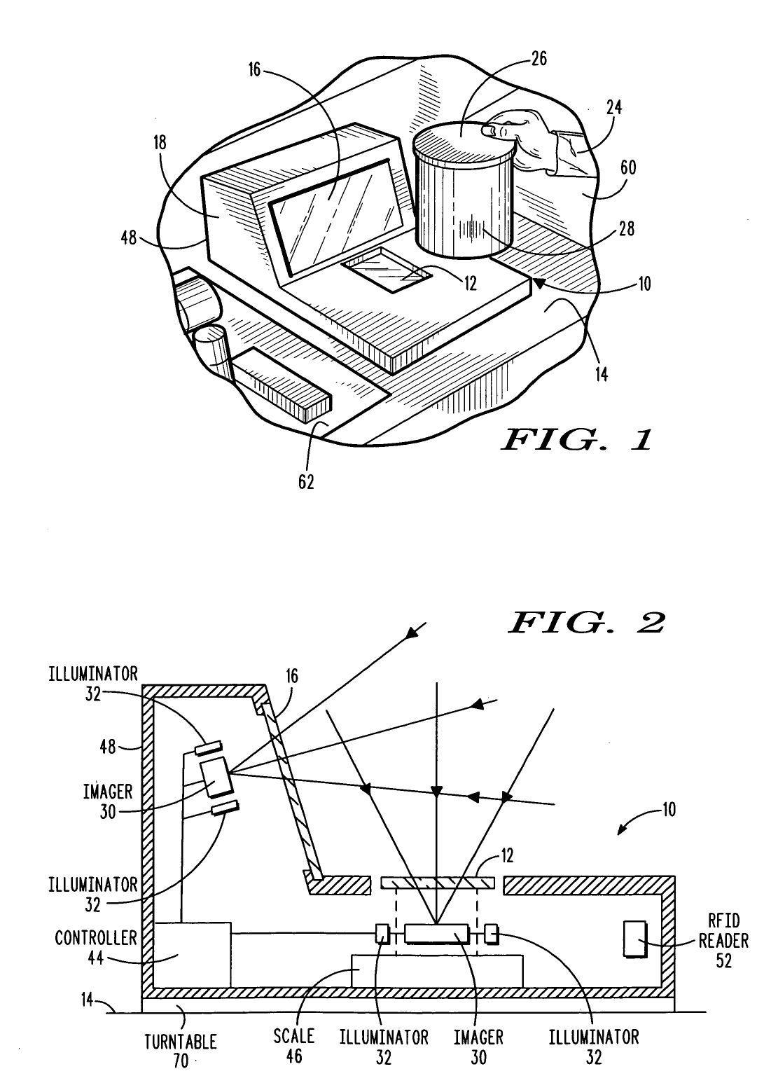

FIG. 1 depicts a dual window, bi-optical, point-of-transaction workstation 10 used by retailers at a checkout stand to process transactions involving the purchase of products bearing an identifying target, such as the UPC symbol described above. Workstation 10 has a generally horizontal window 12 elevated, or set flush with, a countertop 14, and a vertical or generally vertical (referred to as “vertical” or “upright” hereinafter) window 16 set flush with, or recessed into, a raised housing portion 18 above the countertop 14. Workstation 10 either rests directly on the countertop 14, or rests in a well formed in the countertop, or preferably, as best seen in FIG. 2, the workstation 10 is mounted on a movable support structure, such as a turntable 70 for rotation in either circumferential direction relative to the countertop 14, thereby enabling the windows 12, 16 to be selectively positioned to face and be accessible either to a clerk situated at one side of the countertop 14 for traditional clerk service, or to a customer 24 situated at the opposite side of the countertop 14 for either self-service or clerk-assisted service, simply by rotating the workstation. The checkout stand is thus easily converted from traditional clerk service to self-service or clerk-assisted service, without requiring structural modification to the existing checkout stand. Housing portion 18 has a rear wall 48.

As schematically shown in FIG. 2, a data capture arrangement, advantageously including a plurality of imaging readers, each including a solid-state imager 30 and an illuminator 32, is mounted at the workstation 10, for capturing light passing through either or both windows 12, 16 from a target that can be a one- or two-dimensional symbol, such as a two-dimensional symbol on a driver's license, or any document. Each imager 30 is a solid-state area array, preferably a CCD or CMOS array. Each imager 30 preferably has a global shutter. Each illuminator 32 is preferably one or more light sources, e.g., one or more surface-mounted, light emitting diodes (LEDs), located at each imager 30 to uniformly illuminate the target.

In use, the customer 24, as described in detail below, with the windows 12, 16 selectively positioned to face and be accessible to the customer, processes a product 26 bearing a UPC symbol 28 thereon, past the windows 12, 16 by swiping the product across a respective window, or by presenting the product by holding it momentarily steady at the respective window. The symbol 28 may be located on any of the top, bottom, right, left, front and rear, sides of the product, and at least one, if not more, of the imagers 30 will capture the illumination light reflected, scattered, or otherwise returning from the symbol through one or both windows.

FIG. 2 also schematically depicts that a weighing scale 46 and a radio frequency identification (RFID) reader 52 may be mounted at the workstation 10. The generally horizontal window 12 advantageously serves not only as a weighing platter for supporting a product to be weighed, but also allows the return light to pass therethrough. As also schematically shown in FIG. 2, the imagers 30 and their associated illuminators 32 are operatively connected to a programmed microprocessor or controller 44 operative for controlling the operation of these and other components. Preferably, the microprocessor is the same as the one used for decoding the return light scattered from the target and for processing the captured target images.

In operation, the microprocessor 44 sends successive command signals to the illuminators 32 to pulse the LEDs for a short time period of 300 microseconds or less, and successively energizes the imagers 30 to collect light from a target only during said time period, also known as the exposure time period. By acquiring a target image during this brief time period, the image of the target is not excessively blurred even in the presence of relative motion between the imagers and the target.

The energization of the imagers 30 can be manual and initiated by an operator, such as a checkout clerk. For example, the operator can depress a button, or a foot pedal, at the workstation 10. The energization can also be automatic such that the imagers operate in a continuous image acquisition mode, as well as for decoding two-dimensional symbols. In the preferred embodiment, all the imagers will be continuously sequentially energized for scanning symbols until such time as there has been a period of inactivity that exceeds a pre-programmed time interval. For example, if no symbols have been scanned for ten minutes, then after this time period has elapsed, the reader enters a power-savings mode in which one or more of the imagers will be omitted from sequential energization. Alternatively, illumination levels may be reduced or turned off. At least one imager will remain active for periodically capturing images.

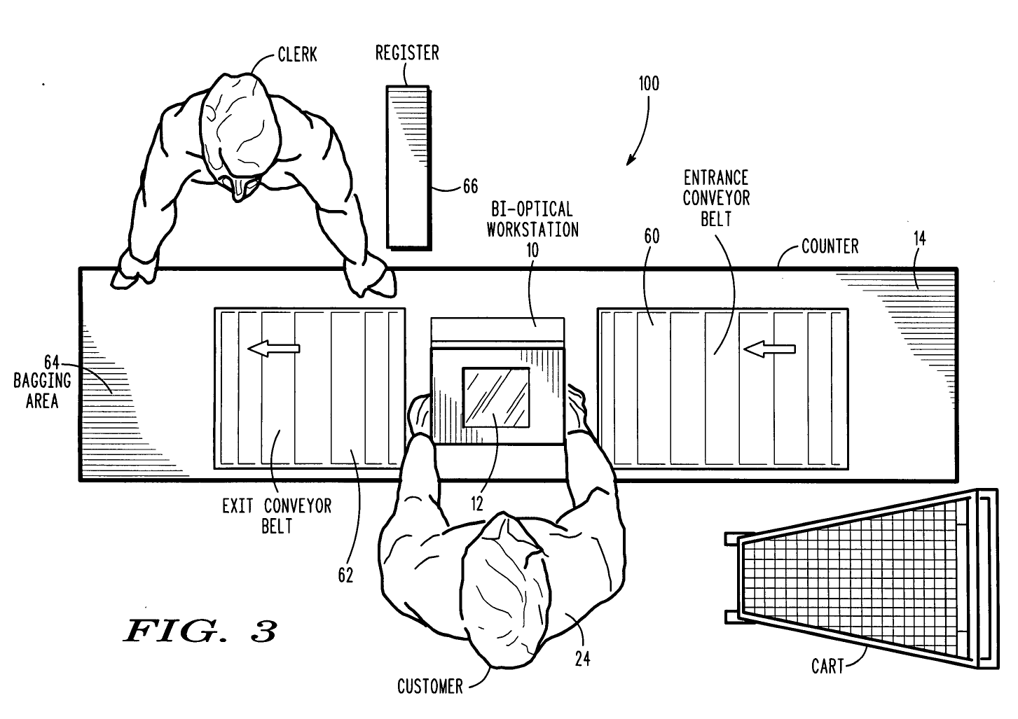

A checkout system 100, as depicted in FIG. 3, includes an entrance conveyor belt 60 located at the countertop 14 at one side of the workstation 10, for conveying the products 26 placed on the entrance conveyor belt 60, preferably by the customer 24, to the workstation 10. An exit conveyor belt 62 is located at the countertop 14 at the opposite side of the workstation 10, for conveying the products 26 placed on the exit conveyor belt 62, preferably again by the customer 24, away from the workstation 10, preferably to a bagging area 64.

In accordance with one aspect of this invention, both of the windows 12, 16 are positioned to face and be accessible to the customer 24 for enabling the customer 24 to interact with the workstation 10 in a self-service mode of operation. Heretofore, self-service was not available when the bi-optical workstation 0 was installed at a checkout system, because the upright window 16 faced the clerk, not the customer 24. The rear wall 48 of the bi-optical workstation rose from the countertop 14 and faced the customer 24 in the prior art. As a result, the customer 24 did not have ready access to either window 12 or 16 of the bi-optical workstation 10 and could not assist in the checkout procedure, even if the customer 24 wanted to, because the rear wall 48 blocked such access. The bi-optical workstation 10 is readily convertible from a traditional clerk-service mode into a self-service mode by moving the workstation, e.g., by preferably turning the workstation, so that both of the windows 12, 16 are positioned to face and be accessible to the customer 24.

A cash register 66 may be provided to enable the clerk to receive payment for the purchased products. The register 66 may include a card reader and a receipt printer to print a receipt for the customer 24. A keypad may also be provided to enable manual entry of information, such as an identifying code for any purchased product not bearing a symbol, by the clerk.

The workstation s relatively inexpensive to install, and can be positioned on the countertop so that its windows both face and are accessible to the customer, thereby maximizing its utilization. The system reduces, if not eliminates, the need for checkout clerks and their associated labor cost, and improves the speed, productivity and efficiency of the checkout operation due to the assistance of the customer. Since the clerk is not directly engaged in the operation of the workstation, the clerk is free to perform other tasks, such as assisting in the bagging of the purchased products, or receiving payment for the purchased products, or finding an identifying code for any purchased product not bearing a symbol, or assisting another customer, etc.

It will be understood that each of the elements described above, or two or more together, also may find a useful application in other types of constructions differing from the types described above. For example, rather than using imaging readers, laser scan generators, as described above, could be employed to replace one, some, or all of the imaging readers. Also, rather than using a turntable to rotate the workstation, other movable structures for moving the workstation could be used. For example, the workstation could be pushed and pivoted about a pivot to position the windows as desired.

While the invention has been illustrated and described as embodied in a checkout terminal and method in which a bi-optical workstation is used, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

We claim:

1. A checkout system, comprising:
a bi-optical workstation having a first window located in a generally horizontal plane, and a second window located in a generally upright plane that intersects the generally horizontal plane, both of the windows facing and being accessible to a customer for enabling the customer to interact with the workstation in a self-service mode of operation; and
a data capture arrangement at the workstation for capturing through at least one of the windows data associated with products to be checked out by the customer during the self-service mode.

2. The system of claim 1, wherein the data is indicia on the products, and wherein the data capture arrangement includes an electro-optical reader for electro-optically reading the indicia.

3. The system of claim 2, wherein the reader includes a plurality of solid-state imagers for capturing light from the indicia through the windows along different fields of view.

4. The system of claim 1, and a support surface on which the workstation is supported.

5. The system of claim 4, and a movable support on which the workstation is mounted for movement relative to the support surface to position the windows to face and be accessible to the customer at one side of the support surface for enabling the customer to interact with the workstation in the self-service mode of operation.

6. The system of claim 4, and an entrance conveyor belt at the support surface for conveying the products placed on the entrance conveyor belt by the customer to the workstation.

7. The system of claim 6, and an exit conveyor belt at the support surface for conveying the products placed on the exit conveyor belt by the customer away from the workstation.

8. A checkout system, comprising:
workstation means having a first window located in a generally horizontal plane, and a second window located in a generally upright plane that intersects the generally horizontal plane, both of the windows facing and being accessible to a customer for enabling the customer to interact with the workstation in a self-service mode of operation; and
data capture means at the workstation means for capturing through at least one of the windows data associated with products to be checked out by the customer during the self-service mode.

9. The system of claim 8, wherein the data is indicia on the products, and wherein the data capture means includes means for electro-optically reading the indicia by capturing light from the indicia through the windows along different fields of view.

10. The system of claim 8, and support means for supporting the workstation means.

11. The system of claim 8, and means for mounting the workstation means for movement relative to the support means to position the windows to face and be accessible to the customer at one side of the support means for enabling the customer to interact with the workstation means in the self-service mode of operation.

12. The system of claim 11, and entrance means at the support means for conveying the products placed on the entrance means by the customer to the workstation means.

13. The system of claim 12, and exit means at the support means for conveying the products placed on the exit means by the customer away from the workstation means.

14. A checkout method, comprising the steps of:
configuring a bi-optical workstation with a first window located in a generally horizontal plane, and with a second window located in a generally upright plane that intersects the generally horizontal plane;
positioning both of the windows to face and be accessible to a customer for enabling the customer to interact with the workstation in a self-service mode of operation; and
capturing through at least one of the windows data associated with products to be checked out by the customer during the self-service mode.

15. The method of claim 14, and configuring the data as indicia on the products, and wherein the capturing step is performed by electro-optically reading the indicia.

16. The method of claim 15, wherein the capturing step is performed by capturing light from the indicia through the windows along different fields of view.

17. The method of claim 14, and supporting the workstation on a support surface.

18. The method of claim 17, and mounting the workstation for movement relative to the support surface to position the windows to face and be accessible to the customer at one side of the support surface for enabling the customer to interact with the workstation in the self-service mode of operation.

19. The method of claim 14, and placing the products on an entrance conveyor belt by the customer, and conveying the products placed on the entrance conveyor belt to the workstation.

20. The method of claim 14, and placing the products on an exit conveyor belt by the customer, and conveying the products placed on the exit conveyor belt away from the workstation.
